(19) United States
(12) Patent Application Publication
(10) Pub. No.: US 2007/0139022 A1
(43) Pub. Date: Jun. 21, 2007

(54) Method and apparatus for detecting input voltage of pwm cycloconverter

(76) Inventors: Eiji Yamamoto, Fukuoka (JP); Hidenori Hara, Fukuoka (JP); Kouichi Eguchi, Fukuoka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/583,253

(22) PCT Filed: Dec. 16, 2004
(86) PCT No.: PCT/JP04/18802

§ 371 Date: Jun. 16, 2006

(30) Foreign Application Priority Data
Dec. 19, 2003 (JP) 2003-422142

(51) Int. Cl. G05F 1/00

(52) U.S. Cl. 323/237

(57) ABSTRACT

An input voltage detection method, for a PWM cycloconverter whose operation can be stably continued though a power voltage sharply fluctuates, and an apparatus therefor are provided.

For a PWM cycloconverter, provided are: an input power voltage phase detector 41, for detecting the phase of three-phase AC power; an artificial DC bus voltage detector 42, for detecting the magnitude of the three-phase AC power; an input voltage upper and lower limit calculator 43, for employing the output of the artificial DC bus voltage detector to calculate upper and lower limits for an input voltage; and a voltage comparator 46, for comparing a voltage value, detected by the artificial DC bus voltage detector, with the upper and lower limit values obtained by the input voltage upper and lower limit calculator. The output of the voltage comparator is adjusted, so that the voltage value detected by the artificial DC bus voltage detector falls within the upper and lower limit values obtained by the input voltage upper and lower limit calculator.

### TECHNICAL FIELD

The present invention relates to a method and apparatus for controlling a power converter that can convert AC power for output at an arbitrary frequency, and relates particularly to a method and apparatus for controlling a PWM cycloconverter that employs a pulse width modulation (PWM) control system.

### RELATED ART

A “PWM cycloconverter and a control method therefor”, disclosed in patent document 1, can be cited as a conventional method for detecting an input voltage for a PWM cycloconverter. Generally, in a PWM cycloconverter, when an abnormality, such as a phase loss, blackout or power unbalance, has occurred in input power, the bidirectional switching device is turned off by the gate block to halt the operation. According to the method in patent document 1, in a case wherein the operation is halted because a power abnormality has occurred, especially one due to an instantaneous blackout, the operation can be immediately continued after the supply of power has been recovered from. FIG. 14 is a calculation flowchart for calculating the instantaneous voltage phase of a PWM cycloconverter disclosed in patent document 1. When an abnormality has occurred in the power for the PWM cycloconverter, phase calculation is performed by employing the instantaneous value of an input voltage. As shown in FIG. 14, one power cycle of 360° is divided by 12, 30° each. First, in order to distinguish a phase interval 1 from an interval 2, whether an input voltage Vr is positive or negative is determined, and when Vr≧0, whether Vs is positive or negative is determined. When Vs≧0, then, whether Vr−Vs is positive or negative is determined. As a result, when Vr−Vs≧0, the phase is identified as an interval 1. When Vr−Vs<0, the phase is identified as an interval 2. Similarly, the remainder of the intervals can be obtained based on the Vr, Vs and Vt relationship. By employing the thus obtained instantaneous phase, the timing is controlled so as to avoid a rush current that flows until the gate block, operational upon the instantaneous blackout, is unlocked after the supply of power has been recovered.

On the other hand, for example, a “protection apparatus for a PWM cycloconverter and a protection method therefor”, disclosed in patent document 2, can be given as an example protection measure, relative to a large surge voltage that is caused by the gate block upon the occurrence of a power abnormality. FIG. 15 is a configuration diagram for the PWM cycloconverter protection apparatus. A power voltage detector 122 receives a power voltage and outputs the phase and the instantaneous value of the power voltage, and a controller 123 prepares gate signals G1xy and C1yx (x=r, s and t; y=u, v and w) for unidirectional switches 103 to 120.

On the other hand, when a voltage information detector 130, which serves as failure detection means, detects the maximum values and the minimum values of r, s and t phases, and determines there has occurred an input abnormality, a protection gate signal generator 150 employs input voltage information to prepare protection process gate signals G2xy and G2yx, a gate signal synthesizer 124 outputs a logical sum of G1 (G1xy or G1yx) and G2 (G2xy or G2yx), and a gate driver 125 turns on or off the 18 unidirectional switches 103 to 120.

Through this arrangement, when the output side of the PWM converter is released in a case wherein the PWM converter is to be de-energized because the operation is abnormal, for example, part of the unidirectional switches are selectively turned on by protection gate signals G2, so as to produce, in a pseudo manner, the same operating state as that of the regeneration circuit of the inverter main circuit. Thus, through a process, such as a process for regenerating, on the input side, the surge voltage of the output side, the protection process at the de-energizing time can be performed.

Patent Document 1: JP-A-2003-309974 (pp. 3 to 4, FIG. 9)

Patent Document 2: JP-A-2000-139076 (pp. 4 to 5, FIG. 1)

### DISCLOSURE OF THE INVENTION

Problems that the Invention is to Solve

However, since the instantaneous value of the input voltage is employed for the conventional input voltage detection method of the PWM cycloconverter described in patent document 1, patent document 2, etc., when a resonance or an instantaneous short circuit has occurred in an input voltage, a problem has arisen in that an error is caused in the calculation of an output voltage, and a voltage actually output differs from a command voltage.

The present invention is provided while taking this problem into account, and the objective of this invention is to provide an input voltage detection method for a PWM cycloconverter, the operation of which can be stably continued, though an input voltage is sharply fluctuated, and an apparatus therefor.

Means for Solving the Problems

In order to resolve the above problem, according to claim 1 of the invention, there is provided with an input voltage detection method, for a PWM cycloconverter that is a power converter, wherein individual phases of three-phase AC power are directly connected to individual phases of a three-phase output of the power converter by employing a bidirectional semiconductor switch that is formed by combining two unidirectional semiconductor switches, to which a current is supplied only in one direction and which are capable of independently being turned on and off,

the input voltage detection method including the steps of:

detecting a phase of the three-phase AC power;

employing the phase of the three-phase AC power and the detected phase of an input power voltage to detect an artificial DC bus voltage that represents a magnitude of the three-phase AC power as a difference between a maximum value and a minimum value;

calculating an ideal input voltage value by using an effective value of the detected artificial bus voltage and the phase of the input voltage;

calculating a permissible width defined by an upper limit and a lower limit relative to the ideal input voltage value thus calculated;

comparing a voltage value of the detected artificial DC bus voltage with the obtained permissible width defined by the upper limit and the lower limit; and

adjusting the voltage value of the detected artificial DC bus voltage within the obtained permissible width defined by the upper limit and the lower limit.

According to claim 2 of the invention, there is provided with the input voltage detection method, for a PWM cycloconverter, according to claim 1, further including the step of:

detecting an abnormality of an input voltage of the three-phase AC power based on the detected artificial DC bus voltage and the detected phase of the input power voltage.

According to claim 3 of the invention, there is provided with an input voltage detection apparatus, for a PWM cycloconverter that is a power converter, wherein individual phases of three-phase AC power are directly connected to individual phases of a three-phase output of the power converter by employing a bidirectional semiconductor switch that is formed by combining two unidirectional semiconductor switches, to which a current is supplied only in one direction and which are capable of independently being turned on and off,

the input voltage detection apparatus including:

an input power voltage phase detector, for detecting a phase of the three-phase AC power;

an artificial DC bus voltage detector, for employing the three-phase AC power and the phase detected by the input power voltage phase detector to detect an artificial DC bus voltage that represents a magnitude of the three-phase AC power as a difference between a maximum value and a minimum value;

an ideal input voltage calculator, for calculating an ideal input voltage value based on an effective value of the artificial bus voltage and the phase of the input voltage;

an input voltage upper and lower limit calculator, for calculating a permissible width defined by upper and lower limits for the obtained ideal input voltage value; and

a voltage comparator, for comparing a voltage value detected by the pseudo DC bus voltage detector with the permissible width defined by the upper and lower limits, which are obtained by the input voltage upper and lower limit calculator,

wherein an output of the voltage comparator is adjusted, so that a voltage value detected by the artificial DC bus voltage detector falls within the permissible width defined by the upper and lower limits, which are obtained by the input voltage upper and lower limit calculator.

According to claim 4 of the invention, there is provided with the input voltage detection apparatus, for a PWM cycloconverter, according to claim 3, further including:

a power abnormality detector, for detecting an abnormality in the three-phase AC power based on an output of the artificial DC bus voltage detector and an output of the input power voltage phase detector, so that an abnormality in the input voltage is detected.

Advantages of the Invention

According to the invention cited in claim 1, the voltage value of the detected artificial DC bus voltage is compared with the obtained permissible width defined by the upper limit and the lower limit, and the voltage value of the detected artificial DC bus voltage is adjusted so as to fall within the obtained permissible width defined by the upper limit and the lower limit. Therefore, the PWM cycloconverter input voltage detection method can be provided, whereby the operation can be stably continued upon the occurrence of a sharp change of the input voltage.

Furthermore, according to the invention cited in claim 2, an abnormality in the input voltage of the three-phase AC power is detected based on the artificial DC bus voltage and the detected phase of the input power voltage. Therefore, an input voltage detection method can be provided whereby the abnormality in an input power voltage can be immediately detected when an input voltage fluctuates so sharply that the main circuit part of the PWM cycloconverter may be destroyed.

Further, according to the invention cited in claim 3, the voltage comparator is included, which compares a voltage value detected by the pseudo DC bus voltage detector with the permissible width defined by the upper and lower limits that are obtained by the input voltage upper and lower limit calculator. And this voltage comparator adjusts a voltage value detected by the artificial DC bus voltage detector so as to be within the permissible width defined by the upper and lower limits that are obtained by the input voltage upper and lower limit calculator. Thus, the input voltage detection apparatus can be provided for a PWM cycloconverter, for which the operation can be stably continued upon the occurrence of a sharp fluctuation of an input voltage.

Moreover, according to the invention cited in claim 4, the power abnormality detector, for detecting an abnormality in the three-phase AC power based on the output of the artificial DC bus voltage detector and the output of the input power voltage phase detector, is included. Therefore, the input voltage detection apparatus can be provided, which can immediately detect an abnormality in an input power voltage when the input voltage fluctuates so sharply that the main circuit portion of a PWM cycloconverter, for detecting an abnormality in an input voltage, may be destroyed.

### BRIEF DESCRIPTION OF THE DRAWINGS

FIG. 1 is a block diagram for a PWM cycloconverter input voltage detection method according to the present invention;

FIG. 2 is a detailed block diagram showing an input power voltage phase/level detector shown in FIG. 1;

FIG. 3 is a diagram showing the relationship between the instantaneous value of an input voltage in FIG. 1, a artificial DC bus voltage and an input voltage phase;

FIG. 4 is an enlarged waveform diagram showing an input voltage at an interval 1 in FIG. 3;

FIG. 5 is a waveform diagram showing an output voltage generation method, employing an artificial DC bus voltage, shown in FIG. 3;

FIG. 6 is a connection diagram showing the state wherein a plurality of power converters, and loads thereof, are connected to a single three-phase power source;

FIG. 7 is a waveform diagram showing the state wherein a power voltage shown in FIG. 3 is distorted;

FIG. 8 is a waveform diagram showing the state wherein the power voltage shown in FIG. 3 is distorted;

FIG. 9 is a waveform diagram for an artificial DC bus voltage in a case wherein power distortion in FIG. 8 has occurred;

FIG. 10 is a waveform diagram for an upper limit voltage value and a lower limit voltage value obtained by an input voltage upper and lower limit calculator shown in FIG. 2;

FIG. 11 is a waveform diagram showing an input voltage value, for which the upper and lower limit values are restricted by a voltage value comparator in a case wherein the power distortion shown in FIG. 8 has occurred;

FIG. 12 is a block diagram for a PWM cycloconverter input voltage detection method according to a second mode of the present invention;

FIG. 13 is an internal block diagram for a conventional input power voltage phase/magnitude detector for a PWM cycloconverter;

FIG. 14 is a calculation flowchart for calculating the instantaneous voltage phase of a conventional cycloconverter; and

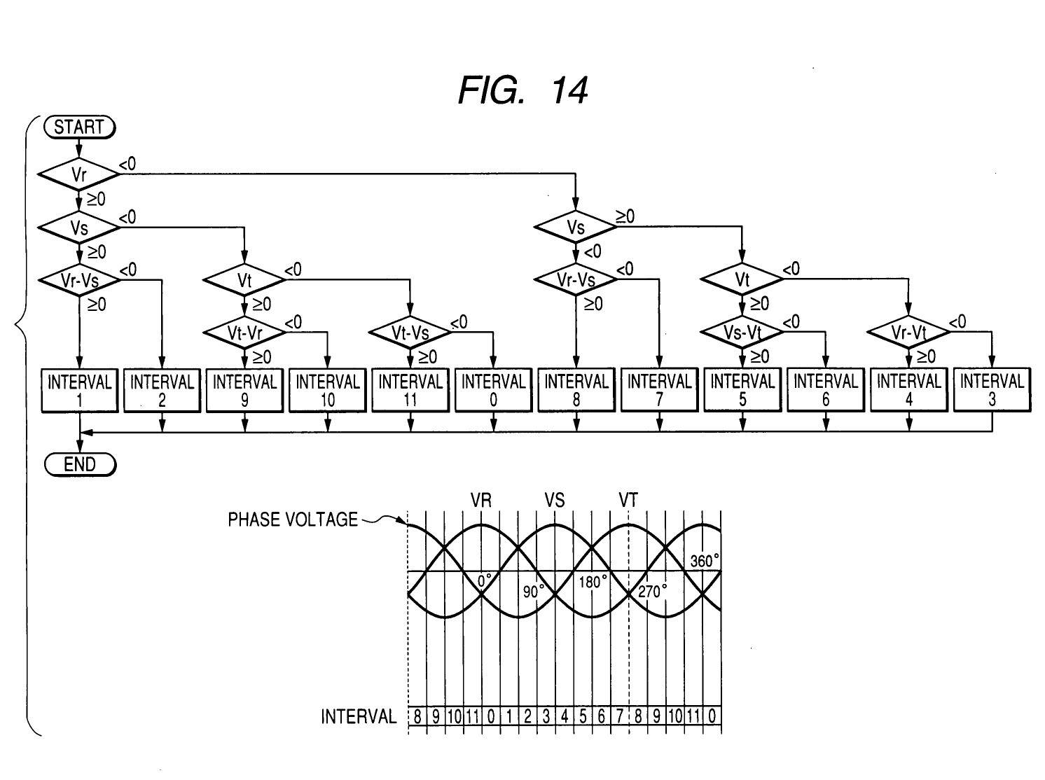

FIG. 15 is a block diagram showing the configuration of a conventional PWM cycloconverter.

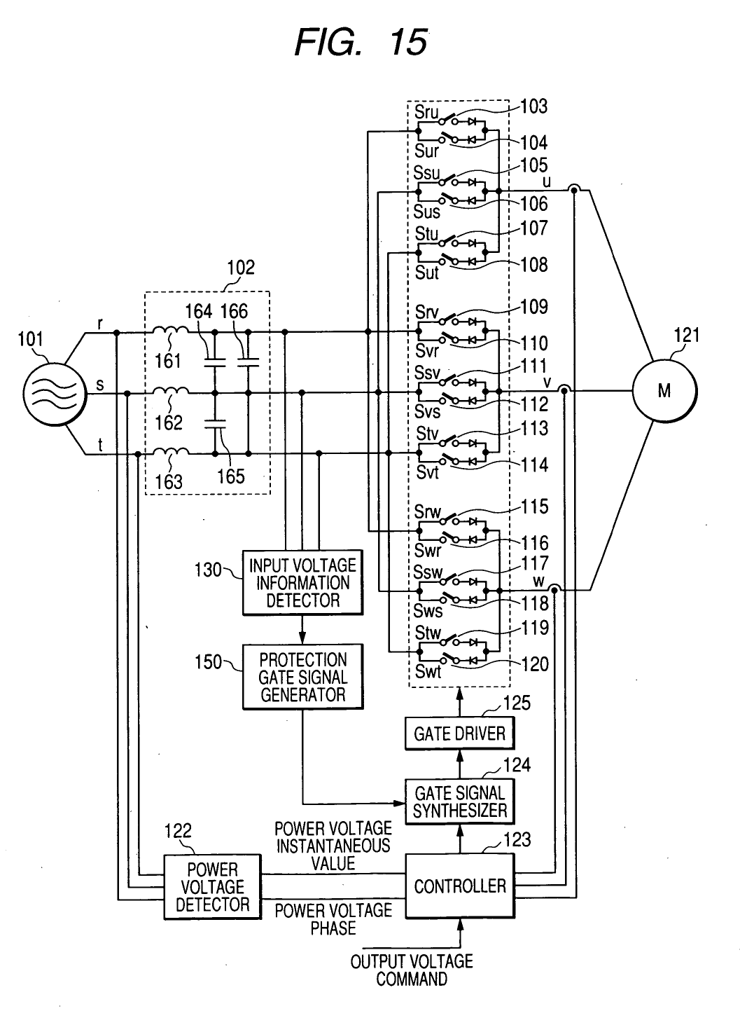

### DESCRIPTION OF REFERENCE NUMERALS AND SIGNS

1: three-phase power source

2: input filter

3: bidirectional switch group

4: input power voltage phase/magnitude detector

5: input voltage value

6: input voltage phase

7: controller

8: drive circuit

9: power voltage abnormal signal

11: thyristor input filter

12: thyristor

13: PWM converter input filter

14: PWM converter

15: inverter

41: input voltage phase detection circuit

42: artificial DC bus voltage detection circuit

43: input voltage effective value detection circuit

44: ideal input voltage calculator

45: input voltage upper and lower limits calculator

46: voltage value comparator

47: input voltage abnormality detection circuit

S1 to S9: bidirectional switch

L1 to L5: load

VR, VS, VT: input voltage

VMAX: maximum input voltage value

VMIN: minimum input voltage value

### BEST MODES FOR CARRYING OUT THE INVENTION

The modes for the present invention will now be described while referring to the drawings.

Mode 1

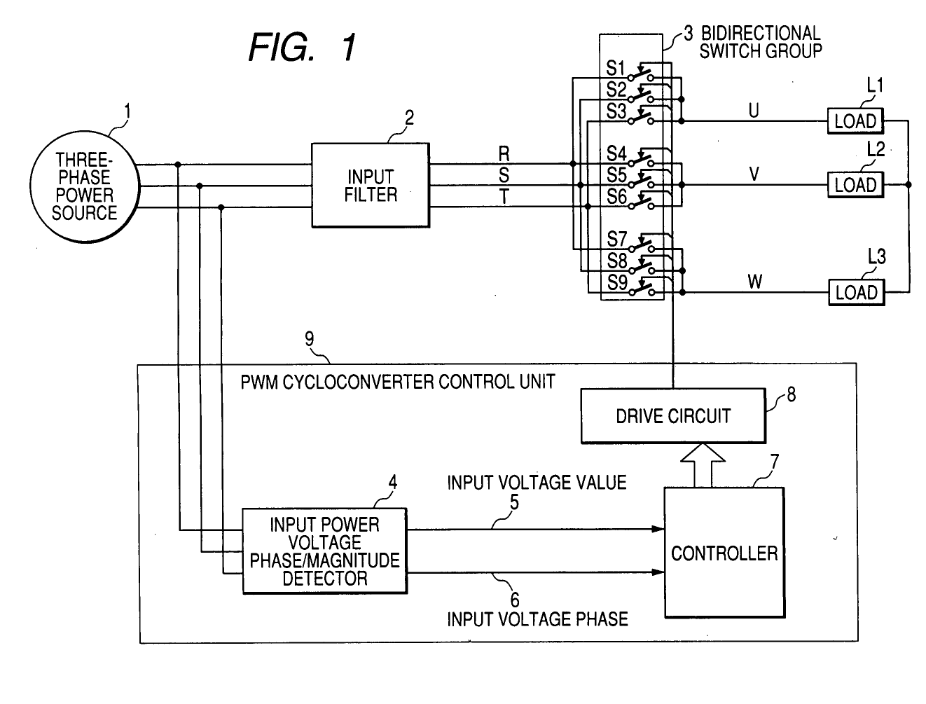

FIG. 1 is a block diagram for a PWM cycloconverter input voltage detection method according to the present invention.

In FIG. 1, an input filter 2 is arranged between a three-phase power source 1 and a bidirectional switch group 3 formed of bidirectional switches S1 to S9, and the output sides of the bidirectional switch group 3 are connected to loads L1 to L3. The input filter 2 and the bidirectional switch group 3 constitute the main circuit of a PWM cycloconverter. A voltage is detected on the input side (the primary side) of the input filter 2, and an input voltage value 5 and an input voltage phase 6, which are required to control a PWM cycloconverter, are detected by an input power voltage phase/magnitude detector 4, and are transmitted to a controller 7. The controller 7 calculates switching times for the bidirectional switches S1 to S9, and transmits the switching times to a drive circuit 8.

The drive circuit 8 drives the bidirectional switches S1 to S9. It should be noted that the input power voltage phase/magnitude detector 4, the controller 7 and the drive circuit 8 constitute a PWM cycloconverter control unit 9.

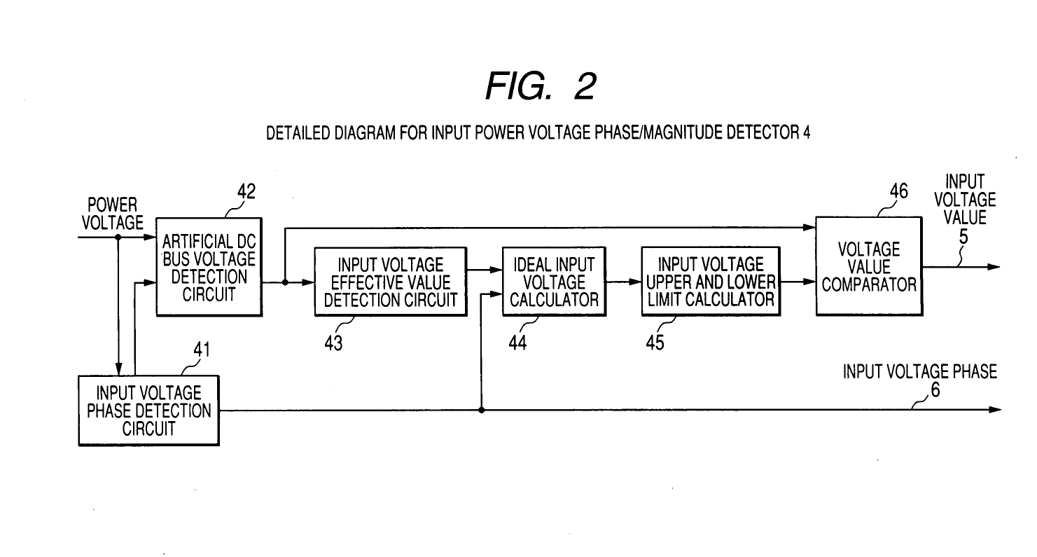

FIG. 2 is a detailed block diagram for the input power voltage phase/magnitude detector shown in FIG. 1.

In FIG. 2, an input is a power voltage shown in FIG. 1, and outputs are the input voltage value 5 and the input voltage phase 6. Based on the power voltage, an input voltage phase detection circuit 41 detects the input voltage phase 6.

In accordance with a phase and a power voltage obtained by the input voltage phase detection circuit 41, an artificial DC bus voltage detection circuit 42 detects an artificial DC bus voltage. By employing the artificial DC bus voltage, an input voltage effective value detection circuit 43 calculates an input voltage effective value, and an ideal voltage calculator 44 employs the input voltage effective value and the input voltage phase 6 to calculate an ideal input voltage value.

An input voltage upper and lower limit calculator 45 calculates an upper limit value and a lower limit value that define a specific width relative to the ideal input voltage value. A voltage value comparator 46 compares the artificial DC bus voltage, obtained by the artificial DC bus voltage detection circuit 42, with the upper limit and lower limit value, which define a specific width relative to the ideal input voltage value that is obtained by the input voltage upper and lower limit calculator 45. Then, the voltage value comparator 46 limits the artificial DC bus voltage within the ideal input voltage value, and outputs the voltage as the input voltage value 5.

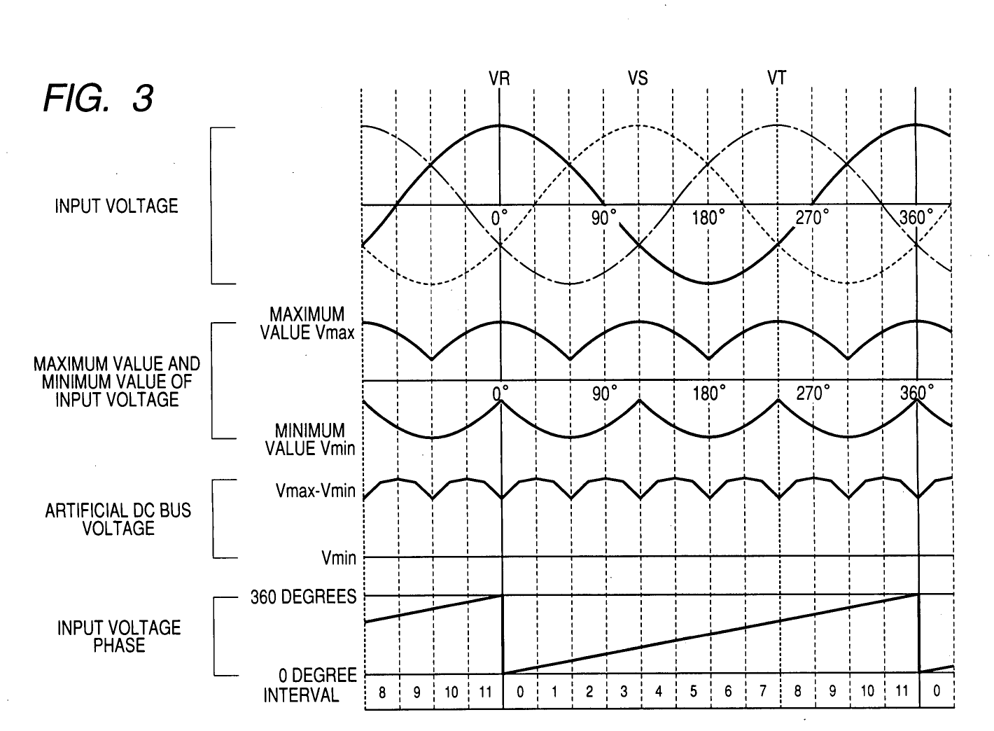

While referring to FIGS. 3 to 5, an explanation will now be given for a basic PWM cycloconverter control method that is the subject for the invention.

FIG. 3 is a waveform diagram showing the relationship between the instantaneous value of an input voltage, an artificial DC bus voltage and an input voltage phase. In FIG. 3, three-phase voltages VR, VS and VT are shown in the input voltage entry. In the following entry for the maximum values and the minimum values for the input voltage, among voltages indicated in the input voltage entry, the maximum phase is indicated as maximum value VMAX and the minimum phase is indicated as minimum value VMIN.

In the entry for the artificial DC bus voltage, maximum value VMAX is shown from the viewpoint of minimum value VMIN, while minimum value VMIN is employed as a reference potential. The artificial DC bus voltage becomes a waveform having six times a power supply frequency. Further, since the succeeding VMAX−VMIN corresponds to the DC bus voltage obtained after a common diode-rectification type inverter has performed rectification, in this case, this is called an artificial DC bus voltage. In the entry for the input voltage phase, the phase relation relative to the input voltage is shown. In this case, the vertex of VR is employed as a reference; however, any point may be employed.

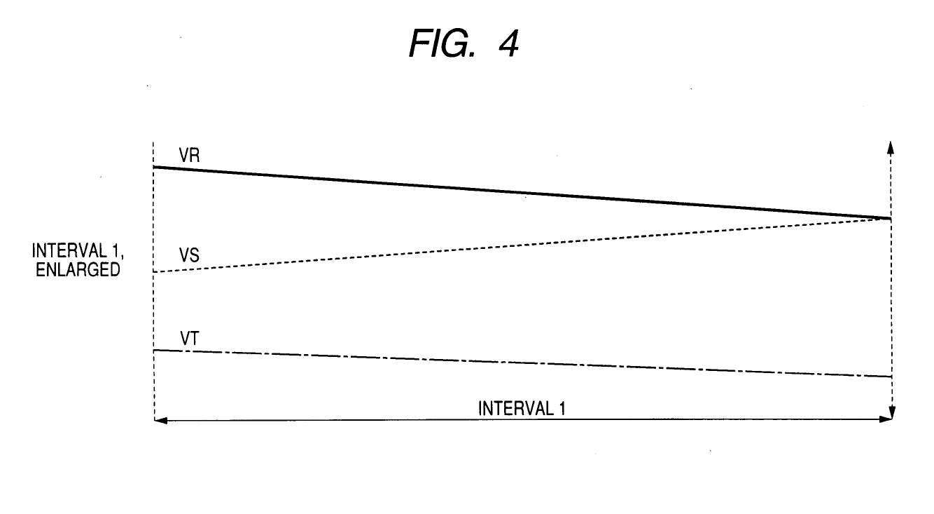

FIG. 4 is a diagram showing the enlarged waveform of the input voltage at an interval 1 shown in FIG. 3.

As shown in FIG. 4, in a very short period of time (normally several tens of micro seconds to several hundreds of micro seconds), the change in an input voltage is very little, and accordingly, the artificial DC bus voltage can be regarded substantially as constant. Of course, the average value for a very short period of time may be calculated, and may be employed as an artificial DC bus voltage.

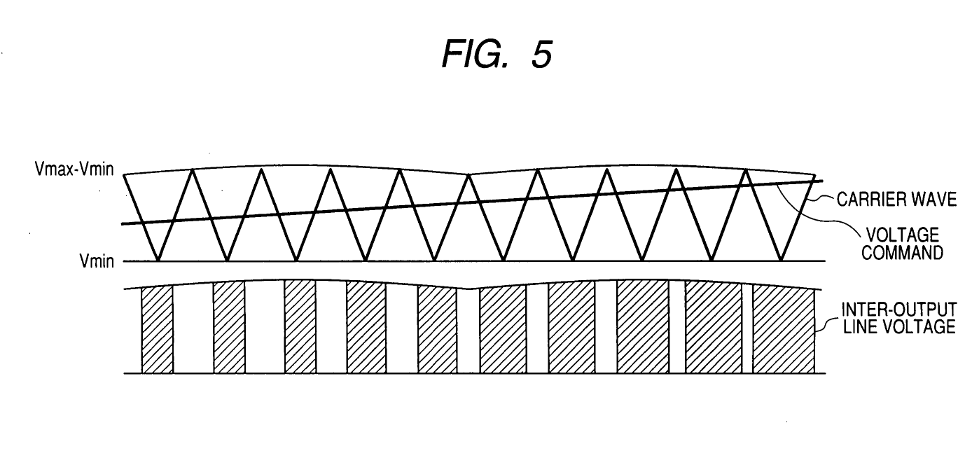

FIG. 5 is a waveform diagram showing an output voltage generation method that employs the artificial DC bus voltage shown in FIG. 3. In FIG. 5, as for the artificial DC bus voltage indicated by the maximum value VMAX−the minimum value VMIN, a carrier wave is compared with the magnitude of a voltage command, and when the magnitude of the voltage command is greater, the bidirectional switches S1 to S9 are controlled so as to output an inter-output line voltage. Since the artificial DC bus voltage is not constant, the width of the inter-output line voltage differs for the same voltage command.

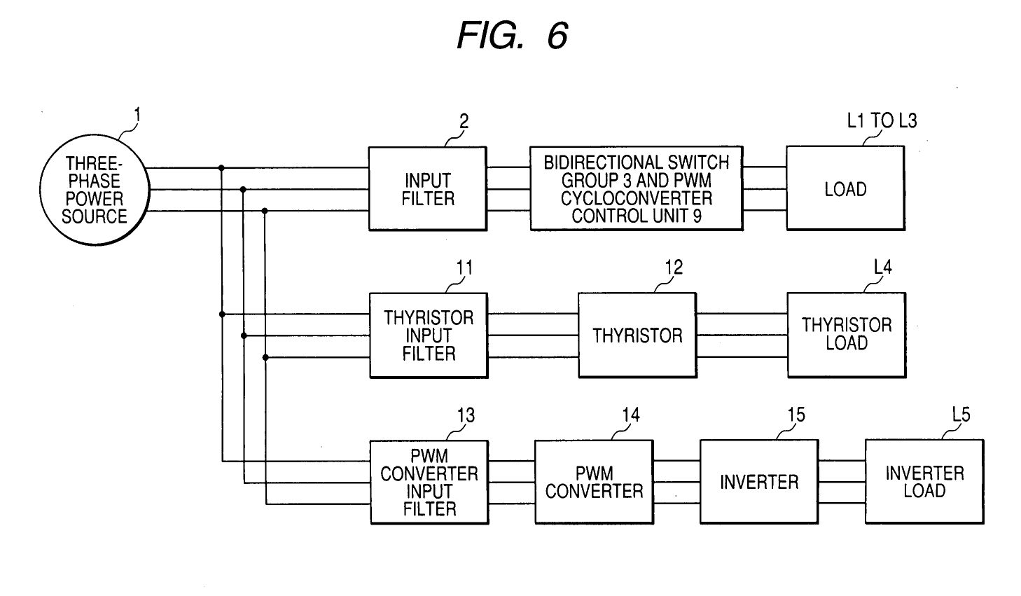

The general usage form of a PWM cycloconverter will now be examined. FIG. 6 is a connection diagram showing the state wherein a plurality of power converters and loads therefor are connected to a single three-phase power source 1. The connection of a plurality of power converters to a single power source, as shown in the example in FIG. 6, can be said is a usage form that is frequently employed.

In FIG. 6, a PWM cycloconverter in the top stage, a thyristor 12 in the middle state, and a PWM converter 14 and an inverter 15 in the bottom stage are connected to a three-phase power source 1 used in common. For the individual power converters, filters (an input filter 2, a thyristor input filter 11 and a PWM converter input filter 13, respectively) are arranged in the input stage, and loads (loads L1 to L3, a thyristor load L4 and an inverter load L5, respectively) are arranged in the output stage.

According to this connection arrangement, an input power voltage will be distorted, depending on the filter circuit configuration provided for the input stages of the power converters and the circuit constants.

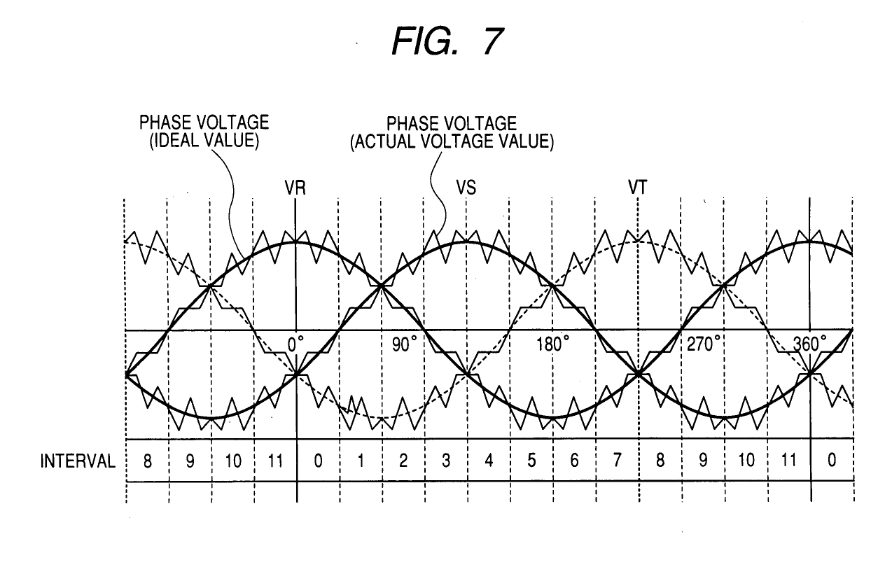

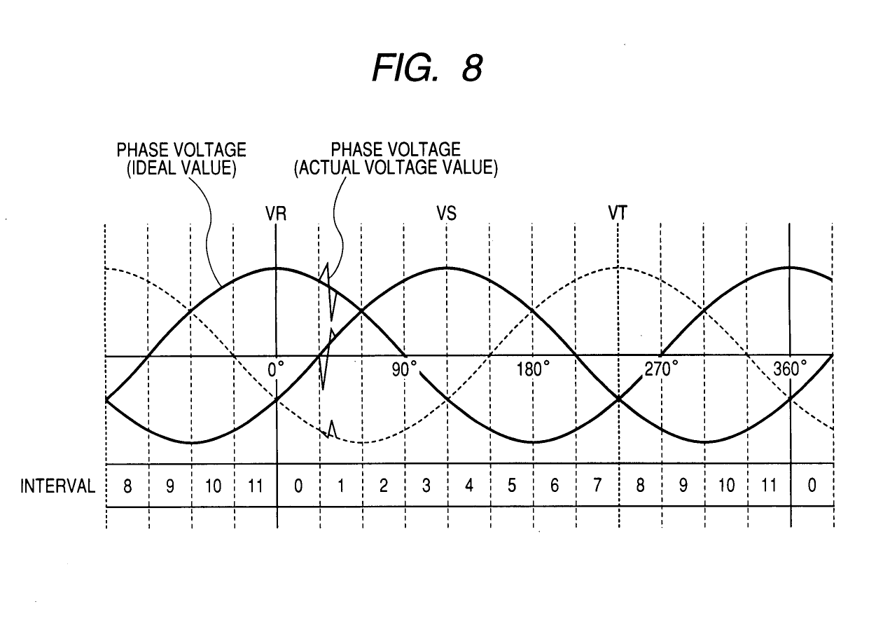

Waveforms in FIGS. 7 and 8 correspond to the states wherein a power voltage is distorted.

In the example in FIG. 7, distortion has occurred during the entire power cycle. In the example in FIG. 8, distortion has occurred in only one part of one power cycle.

The factor that causes distortion during the entire cycle as shown in FIG. 7 can be an example wherein filters provided in the input stages become resonant relative to each other. The factor that causes distortion in one part of the cycle, as shown in FIG. 8, is a short circuit of the power when each of the power converters is powered on, or when commutation of the thyristor 12 or the switching of the PWM converter 14 occurs.

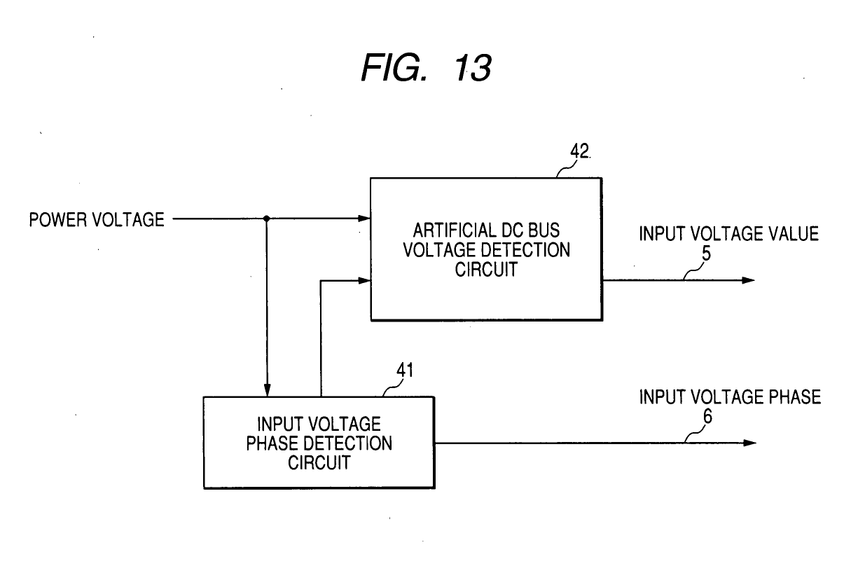

FIG. 13 is an internal block diagram showing a conventional input power voltage phase/magnitude detector 4, for a PWM cycloconverter, for comparison with the configuration of the present invention shown in FIG. 2.

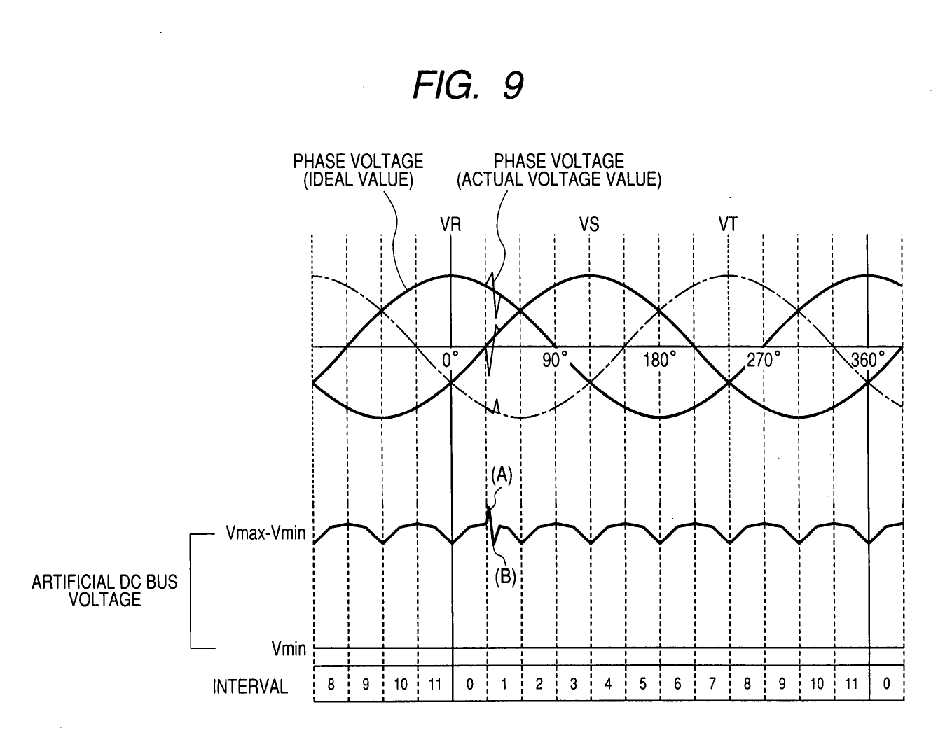

According to the conventional example, as shown in FIG. 13, an input voltage value 5 and an input voltage phase 6 are calculated directly, based on a power voltage. Therefore, in the case shown in FIG. 13, distortion shown in FIG. 9, like the power distortion shown in FIG. 8, has occurred in the waveform of an artificial DC bus voltage. As shown in FIG. 5, to control the PWM cycloconverter, the output voltage is prepared based on the magnitude of the artificial DC bus voltage, during a very short interval, for the input voltage and the voltage command. At this time, for the artificial DC bus voltage obtained in (A) in FIG. 9, the input voltage is detected as a value that is greater than the actual value, while for the artificial DC bus voltage obtained in (B) in FIG. 9, the input voltage is detected as a value that is smaller than the actual value. As a result, in (A), an output voltage lower than the command voltage is output, while in (B), an output voltage higher than the command voltage is output.

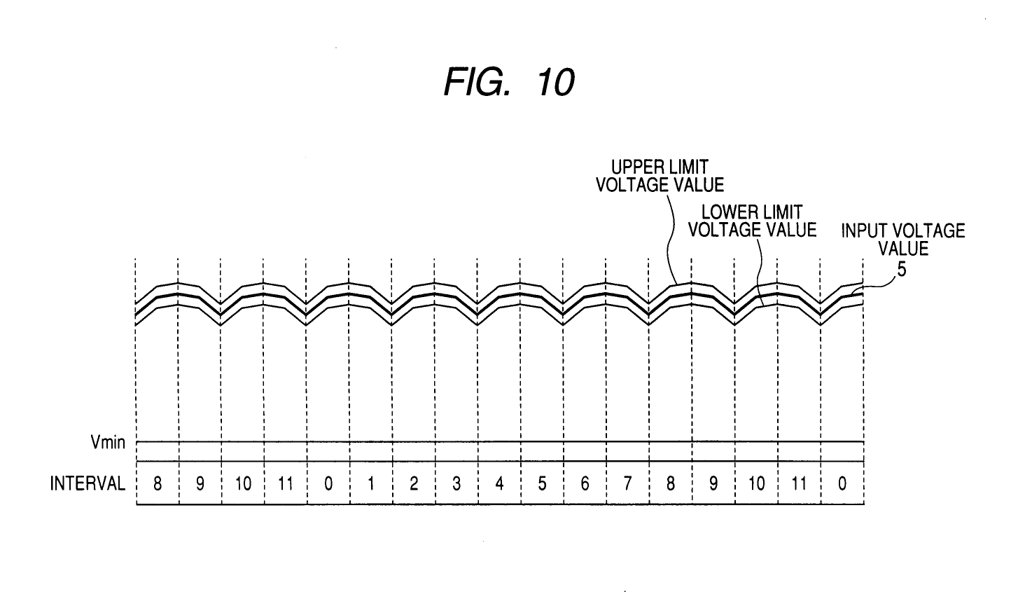

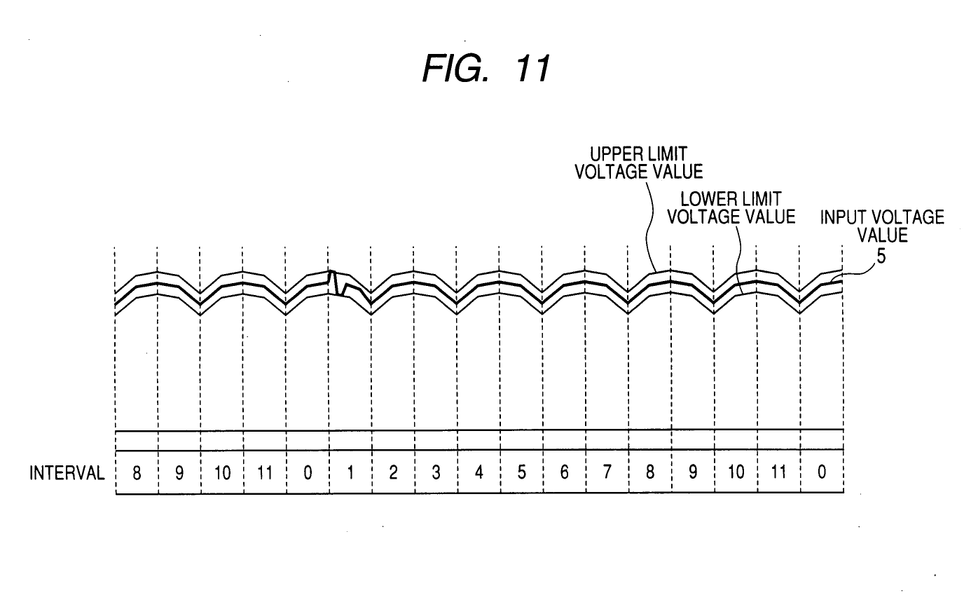

On the other hand, according to the invention, as shown in FIG. 2, the voltage value comparator 46 compares the artificial Dc bus voltage, obtained by the artificial DC bus voltage detection circuit 42, with the upper limit value and the lower limit value, which define a specific width relative to the ideal input voltage value that is obtained by the input voltage upper and lower limit calculator 45. And the voltage value comparator 46 limits the artificial DC bus voltage to the input voltage ideal value, and employs this voltage as the input voltage value 5. In FIG. 10, waveforms are shown for the upper limit voltage value and the lower limit voltage value obtained by the input voltage upper and lower limit calculator 45. Further, in FIG. 11, a waveform is shown for the input voltage value 5, for which the upper and lower limit values are restricted by the voltage value comparator 45 when the power distortion shown in FIG. 8 has occurred. Thus, instantaneous distortions, such as (A) and (B), can be absorbed.

It should be noted that predesignated fixed values may be employed, instead of the upper and lower limit values calculated by the input voltage upper and lower limits calculator 45, or the values may be changed in accordance with the power condition or the resonance levels of input voltages or the power converters connected to the same power source.

Mode 2

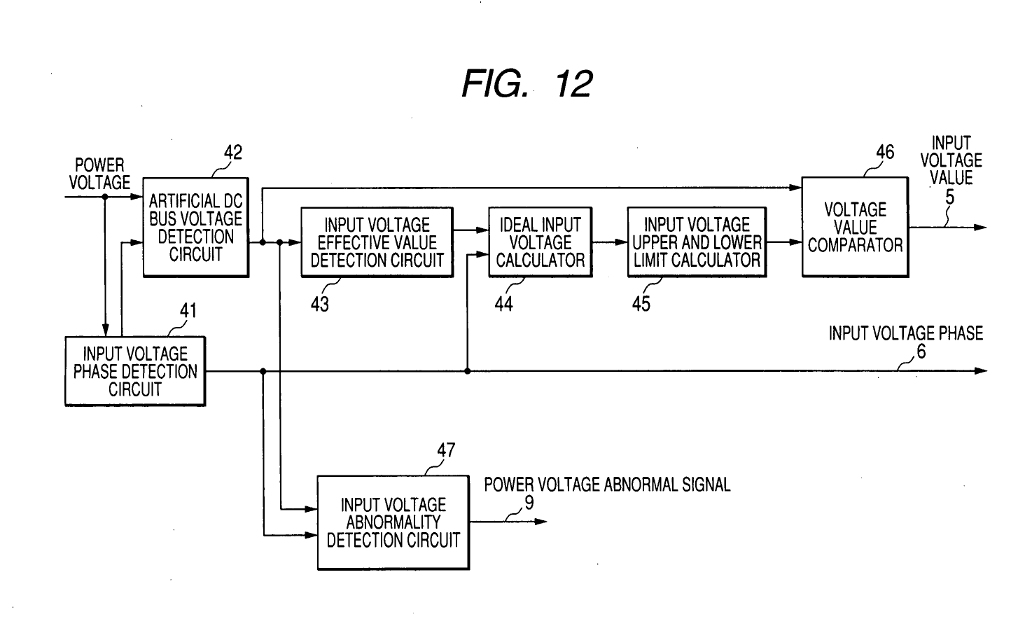

FIG. 12 is a block diagram for a PWM cycloconverter input voltage detection method according to a second mode of the invention.

An input voltage value 5, employed for controlling a PWM cycloconverter, may differ from an actual input voltage, depending on a voltage value comparator 46. When, for example, an input voltage exceeding the voltage resistance of bidirectional switches S1 to S9 is applied, the operation must be immediately halted from the viewpoint of the protection of a power converter. Therefore, an input voltage value detected by an artificial DC bus voltage detection circuit 42 is transmitted to an input voltage abnormality detection circuit 47, and an abnormality in the input voltage is detected. The input voltage abnormality detection circuit 47 calculates an input power frequency based on a phase detected by an input voltage phase detection circuit 41. When the input power frequency exceeds a predesignated upper or lower limit frequency, a power voltage abnormal signal 9 is output.

Further, when a voltage value detected by the artificial DC bus voltage detection circuit 42 exceeds a predesignated upper or lower limit voltage value, a power voltage abnormal signal 9 is also output.

It should be noted that the input voltage phase detection circuit 41 detects the phase of the input voltage by employing one of three methods, such as (1) a method whereby two voltages of three-phase power are transmitted to a comparator through a transformer and phase data are obtained through a phase frequency comparator (PFD), a filter, a voltage control oscillator (VCO) and a counter, (2) a method for employing a timer to measure the length from one edge to the other edge of a rectangular wave for the output of a comparator, and (3) a method whereby the instantaneous value of an input voltage is fetched by a CPU through AD conversion, and the phase is detected by software.

According to the present invention, to perform the input voltage detection required for controlling a PWM cycloconverter, relative to a sharp change in an input voltage, the operation can be stably continued, and upon the occurrence of a sharp fluctuation in an input voltage that may destroy the main circuit parts of a PWM cycloconverter, the abnormality in the input power voltage can be immediately detected.

1. An input voltage detection method, for a PWM cycloconverter that is a power converter wherein individual phases of three-phase AC power are directly connected to individual phases of a three-phase output of the power converter by employing a bidirectional semiconductor switch that is formed by combining two unidirectional semiconductor switches, to which a current is supplied only in one direction and which are capable of independently being turned on and off,
the input voltage detection method comprising the steps of:
detecting a phase of the three-phase AC power;
employing the phase of the three-phase AC power and the detected phase of an input power voltage to detect an artificial DC bus voltage that represents a magnitude of the three-phase AC power as a difference between a maximum value and a minimum value;
calculating an ideal input voltage value by using an effective value of the detected artificial bus voltage and the phase of the input voltage;
calculating a permissible width defined by an upper limit and a lower limit relative to the ideal input voltage value thus calculated;
comparing a voltage value of the detected artificial DC bus voltage with the obtained permissible width defined by the upper limit and the lower limit; and
adjusting the voltage value of the detected artificial DC bus voltage within the obtained permissible width defined by the upper limit and the lower limit.

2. The input voltage detection method, for a PWM cycloconverter, according to claim 1, further comprising the step of:
detecting an abnormality of an input voltage of the three-phase AC power based on the detected artificial DC bus voltage and the detected phase of the input power voltage.

3. An input voltage detection apparatus, for a PWM cycloconverter that is a power converter wherein individual phases of three-phase AC power are directly connected to individual phases of a three-phase output of the power converter by employing a bidirectional semiconductor switch that is formed by combining two unidirectional semiconductor switches, to which a current is supplied only in one direction and which are capable of independently being turned on and off,
the input voltage detection apparatus comprising:
an input power voltage phase detector, for detecting a phase of the three-phase AC power;
an artificial DC bus voltage detector, for employing the three-phase AC power and the phase detected by the input power voltage phase detector to detect an artificial DC bus voltage that represents a magnitude of the three-phase AC power as a difference between a maximum value and a minimum value;
an ideal input voltage calculator, for calculating an ideal input voltage value based on an effective value of the artificial bus voltage and the phase of the input voltage;
an input voltage upper and lower limit calculator, for calculating a permissible width defined by upper and lower limits for the obtained ideal input voltage value; and
a voltage comparator, for comparing a voltage value detected by the pseudo DC bus voltage detector with the permissible width defined by the upper and lower limits, which are obtained by the input voltage upper and lower limit calculator,
wherein an output of the voltage comparator is adjusted, so that a voltage value detected by the artificial DC bus voltage detector falls within the permissible width defined by the upper and lower limits, which are obtained by the input voltage upper and lower limit calculator.

4. The input voltage detection apparatus, for a PWM cycloconverter, according to claim 3, further comprising:
a power abnormality detector, for detecting an abnormality in the three-phase AC power based on an output of the artificial DC bus voltage detector and an output of the input power voltage phase detector, so that an abnormality in the input voltage is detected.
